(19) United States
(12) Patent Application Publication
(10) Pub. No.: US 2011/0274968 A1
(43) Pub. Date: Nov. 10, 2011

(54) TITANIUM COMPOSITE ELECTRODES AND METHODS THEREFORE

(75) Inventors: Stephen Harrison, Benicia, CA (US); Chulheung Bae, Alameda, CA (US); David Hodgson, Nottingham Nottinghamshire (GB)

(73) Assignee: ITI SCOTLAND LIMITED, GLASGOW (GB)

(21) Appl. No.: 13/141,560

(22) PCT Filed: Dec. 23, 2009
(86) PCT No.: PCT/GB09/51773

§ 371 Date: Jun. 22, 2011

Related U.S. Application Data
(60) Provisional application No. 61/140,301, filed on Dec. 23, 2008.

(51) Int. Cl. H01M 10/08; H01M 4/04; H01M 10/18; H01M 10/12; H01M 4/02; H01M 4/62

(52) U.S. Cl. 429/188; 429/231.5; 429/217; 429/210; 264/104

(57) ABSTRACT

The present invention provides composite electrodes that comprise a titanium metal filler and a polymeric material. Advantageously the composite electrodes of the present invention do not suffer from the problems of carbon degradation, are thermally stable, are easily shaped, which demonstrate high power densities and which are relatively inexpensive to produce.

### CROSS-REFERENCE TO RELATED APPLICATIONS

This application is a United States national phase application under 35 U.S.C. §371 of International Patent Application No. PCT/GB2009/051773 filed on Dec. 23, 2009, and claims the benefit of U.S. Provisional Patent Application No. 61/140,301 filed on Dec. 23, 2008 which are herein incorporated in their entirety by reference. The International Application was published as International Publication No. WO 2010/073050 on Jul. 1, 2010.

### FIELD

The field of the invention is composite electrodes, and especially as it relates to titanium-containing polymeric materials in electrodes.

### BACKGROUND

Among other demands for electrodes in various electrochemical processes, mechanical and chemical stability is typically critical for reproducible/predictable performance and power efficiency. To satisfy such demands, electrodes can be formed from metals. While metals have generally a very high stability, metal electrodes (e.g., platinum electrodes) are typically cost prohibitive. Moreover, metal electrodes are often difficult to shape in the desired geometry and require restrictive joining with other components of an electrochemical cell.

Alternatively, carbon may be used as electrode material, which may or may not be coated with metals to form a catalyst layer. Carbon is significantly less expensive and often can be shaped using relatively simple methods. However, carbon is often degraded by for example being consumed (oxidized) during the electrochemical process and so requires frequent replacement. In further known methods, carbon can also be incorporated as a conductor into a polymer that can be molded into a range of shapes at low cost and that allows ready joining of the composite electrodes to other plastic cell components (e.g. cell frames). However, as with bulk carbon, composite polymers that include carbon or graphite particles are often subject to degradation, for example by anodic oxidation.

To increase stability, titanium suboxide (Magneli phase suboxides of titanium) can be incorporated into electrodes as bulk materials as described in U.S. Pat. No. 5,173,215, and even into conductive polymers as described in U.S. Pat. No. 7,033,696. While such electrodes are often superior to carbon composites, various disadvantages nevertheless remain. For example, preparation of titanium suboxide materials may be expensive and may at least in some cases fail to provide satisfactory conductivity. In other known methods, refractory titanium compounds (e.g., nitrides and borides) can be incorporated into electrodes as described in U.S. Pat. No. 6,015,522. However, such compounds are generally non-conducting and often provide only thermal and chemical stability. Similarly, as described in Polymer Testing 20 (2001) 409-417, zinc can be used as a filler in polyethylene to so form a conductive plastic. Unfortunately, such materials showed poor mechanical properties and only moderate conductivity. Other composite materials between a polymer and copper, nickel, and iron were described in Powder Technology 140 (2004) 49-55. Here, variability in various parameters was a function of pressure, and formation of oxide layers was detrimental to material performance.

In still further known composite materials, gaskets with halogenated plastics and metal powders were described in EP 0 038 679 where PVC resin and plasticizer and zinc (and other metals) were used to form a rubber-like gasket with moderate conductivity. Yet other conductive materials and uses were described in Polymer Engineering And Science (2002) Vol. 42, No. 7, pages 1609 et seq. However, all or almost all of the metals in the composites formed metal oxides that significantly reduced conductivity.

Therefore, while numerous electrodes and conductive polymer compositions are known in the art, all or almost all of them suffer from one or more disadvantages. Thus, there is still a need to provide improved composite materials and electrodes.

### SUMMARY

The Applicants have surprisingly found that it is possible to significantly improve the performance of polymer composite electrodes not only by ensuring that they have a conductivity comparable with carbon electrodes, but also by providing polymer composite electrodes that do not suffer from the problems of carbon degradation, are thermally stable, are easily shaped and demonstrate high power densities. The polymer electrodes of the present invention are also advantageous in that they are relatively inexpensive to produce.

Thus, the present invention provides a composite electrode comprising a polymeric material and metallic titanium.

Preferably, the metallic titanium in the present invention is used in relatively high quantities as a filler in a polymeric matrix; this forms a conductive polymer that can be coated with a range of functional coatings, including those that are catalytic and resistant to degradation, to produce the desired polymer composite electrode.

Titanium metal in any form may be used in the present invention but preferably the metallic titanium is used in small particulate form such as powder, swarf, shavings, filings, chips, fibres, in the form of a mesh, non-woven web or layer or in the form of a sponge or foam, or any form similar to any of the above. It is also important to realise that any titanium from any source is capable of being turned into an effective electrode.

Titanium powder is available from one of three sources and at a range of costs. Gas atomised powder is a very pure, fine spherical powder and can be bought for £100-£150 kg⁻¹. Hydride dehydride (HDH) powder is made by hydriding raw titanium metal to make it brittle and therefore easy so turn into powder, and dehydriding to remove nitrogen. The resulting powder is less expensive at around £50-£70 kg⁻¹. Titanium sponge fines from for example the Kroll process can be bought for approx. £30 kg⁻¹. The titanium used by the Applicants may be derived from waste sources and refined using the HDH process and costs somewhere between the above two sources. Thus, the material the Applicants use is attractive from a cost perspective and also from a purity and particle size control perspective. An additional waste source is that of swarf generated from machining processes. Equally, new titanium powder production processes, e.g. the Armstrong Process and the FFC Cambridge Process, claim to produce titanium powders at much lower cost than the current production methods such materials can also be used by the Applicant in the present invention.

Most typically, the titanium component has a relatively high ratio of surface area to weight and one way to achieve this is to use titanium material with a small particle size. In the case where titanium powder is used, at least 50% of the particles are from 0.5 micron to 500 microns, preferably at least 50% of the particles are from 1 micron to 400 microns and particularly preferred at least 50% of the particles are 2 microns to 300 microns. The particles may be of uniform particle size however, to optimize the conductivity of the polymer composite, it has been found advantageous to use titanium with a mixture of particle sizes. For example, using titanium powder comprising a blended mixture of particles derived from a first source having at least 50% of the particles being 200 micron and a second source having at least 50% of the particles being 400 micron exhibits higher conductivity than only using titanium with a particle size from one of the sources. Consequently it is particularly advantageous to use titanium with two or more particle sizes.

In the case where the titanium is in swarf, shaving, filing, chip, fibre, in the form of a mesh, non-woven web or layer or in the form of a sponge or foam, or any form similar to any of the above, larger particle sizes may be used. For example, it is preferred that at least 50% of the titanium particles have a largest dimension of 1 to 100 mm, preferably 1 to 50 mm, further preferably up to 5 mm, more preferably equal or less than 1 mm, and most preferably equal or less than 0.5 mm. However, other shapes are also contemplated and may include irregular shapes, interlocking shapes, etc. As discussed above in relation to the powder form, it is highly advantageous to use titanium swarf, shavings, filings, chips, fibres, in the form of a mesh, non-woven web or layer or in the form of a sponge or foam or in any for similar to any form listed above, with two or more particle sizes.

In use, the polymer composite electrode may be installed with an electrolyte at ambient temperature, heated to a higher operating temperature and then subsequently cooled. The maximum operating temperature will be determined by the nature of the polymer used in the composite electrode. In the case where polyethylene is used, it may be convenient to cycle between ambient temperature and about 60° C. During thermal cycling, the Applicants have observed that the titanium particles move towards and away from each other. Thus, having a mixture of two or more particle sizes produces a good cohesive mix that ensures the maintenance of titanium-titanium particle contact and thus maximizes conductivity. The desirability of using a mixture of two or more particle sizes also assists to lower the cost of the polymer composite electrodes of the present invention; titanium metal swarf for example is produced as a waste product and is a cheap source of titanium metal that comprises a mixture of particle sizes. Excellent conductivity is also obtained when powdered titanium with one or more particle sizes is used in conjunction with any one or more of titanium swarf, shavings, filings, chips, fibres or mesh, non-woven web or layer or with titanium sponge or foam or any form similar to any form listed above, with one or more particle sizes.

It is still further generally preferred that the titanium components (most typically in the presence of polymeric material) are at least partially compressed, during either a compression moulding, an extrusion moulding or an injection moulding processing step, in order to increase the area of conductive contact among the titanium particles. It is desirable to apply some heat when compressing to make the polymer softer and therefore more mouldable.

As mentioned above, a highly preferred form of metallic titanium is titanium swarf produced as a waste product from any titanium component manufacturer, for example, from the machining of titanium by the aerospace industry. The shape of the generally elongate strands of titanium metal makes it easier to ensure that the metal pieces touch each other when formed within the polymer composite to provide a particularly good conductive path and weight for weight the conductivity using titanium swarf is higher than using titanium powder. As mentioned above, advantages can be gained through the use of a mixture of titanium swarf and titanium powder. In the present invention, titanium swarf can be used either in its raw dimensions or after processing into smaller particles. The size of the swarf particles used varies according to what is available but the length of at least 50% of the particles is preferably 1 mm to 100 mm, further preferably 1 to 50 mm, more preferably up to 5 mm, still more preferably equal or less than 1 mm, and most preferably equal or less than 0.5 mm. The width of the swarf is preferably 0.1 to 5 mm and preferably 1 to 3 mm, and the thickness of the swarf is preferably 50 to 500 microns thick. These particle dimensions are also preferred for the non-powder forms of the titanium material. The titanium material can be used as supplied, but it is helpful if pre-treated for example to degrease it or to etch it with an acid to provide more surface roughness and/or to remove surface oxide layers. In a typical aspect of the inventive subject matter, a composite material is prepared from a metallic titanium component and a polymer component, wherein the titanium component is present in an amount effective to achieve desirable conductivity. Most typically, the amount will be such that individual titanium particles connect together to form a conductive path. Therefore, and dependent on the form of the titanium used, particular shape and manner of manufacture, suitable amounts of the titanium component in powder form will typically be above 10 wt %, more typically above 20 wt %, even more typically above 50 wt %, and most typically above 60 wt %. Up to 90% Ti in powdered form provides significant benefit. Further, as mentioned above the amount of titanium swarf used is preferably up 20 weight percent and more preferably up to 50 weight percent.

A conductive electrode can be produced from either using the raw swarf-plastic mixture or by form processing the titanium metal into a powder and producing a uniform composite. It is expected that titanium material in non-powder form is required at levels of up to 20% wt to produce an electrode, but more preferably up to 50%. The thickness of the titanium-polymer composite layer when in use in an electrode is typically 0.1 to 10 mm and preferably 0.5 to 5 mm. Gauging the correct thickness of the Ti-polymer composite layer is a balance between cost, resistivity and rigidity—all of these parameters increase with increased thickness but it is desirable to minimize the first two and maximize the third.

Most typically, no oxides of titanium are deliberately added to the titanium-polymer composites of the present invention, and although a very thin natural layer of TiO₂ is formed on the surface of the titanium upon exposure to air, this fortunately is insufficient to interfere with the conductivity of the composite electrode. Nevertheless, in at least some aspects of the inventive subject mater, the titanium filler may further include oxidized species (e.g., TiO, Ti02, Ti203, Ti₃0₅), and especially Magneli phase suboxides, as minor components of the composite electrode.

With respect to the polymer it is contemplated that the polymer is acid resistant, and most preferably a mechanically durable polymer. Therefore, suitable polymers especially include high-density polyethylene (HDPE), polyethylene (PE), ultra-high molecular weight polyethylene (UMHPE) and any other grades of PE, high-density polypropylene (HDPP), polypropylene (PP), polytetrafluoroethylene (PTFE), polyvinylidene difluoride (PVDF), phenolic resins and vinyl esters and all reasonable polymeric mixtures. In the case where an aggressive electrolyte system is being employed, for example in an electrochemical process using Ce⁴⁺, the preferred polymers are one or more of polyethylene, polyvinylidene fluoride and polytetrafluoroethylene. Of course, it should be noted that the polymeric phase may further comprise one or more functional ingredients, and suitable ingredients include those that increase conductivity, mechanical and/or thermal stability and catalytic properties. Similarly, it should be appreciated that contemplated electrodes may be modified on one or both surfaces with additional coatings to achieve a particularly desired property. For example, contemplated electrodes can be further functionalized with one or more suitable catalysts. Examples of suitable catalysts include but are not limited to Pt, Ir02, Ru02 (or mixtures), Ta and carbon/graphite. The surfaces can be functionalized by electroplating, vapor deposition, mechanical derivatization, etc. Therefore, and viewed from a different perspective, it is contemplated that the condutive composite polymers (and especially where they are configured as an electrode) can be coated or otherwise covered (e.g., via electrode deposition, CVD, plasma spray coating, PVD etc.) with one or more conductive materials. Such materials will especially include one or more metals, metal-containing compounds, carbon, conductive polymers, and all reasonable mixtures thereof. Moreover, and especially where the electrode is configured as a bipolar electrode, it should be noted that the active sides of the electrode may be functionalized differently from each other (e.g., one side coated with Pt, the other bonded to a CHDPE layer [e.g., carbon containing high-density polyethylene]).

In one exemplary method, the small particulate titanium is titanium powder with an average grain size of between about 200-400 micron and is present in an amount of at least 60 wt % in a high-density polymer (e.g., HDPE). The powder is preferably mixed with thermoplastic materials to allow hot press forming into a desired shape. Most notably, such composite materials showed desirable performance characteristics and exhibited significant stability, even under relatively harsh reaction conditions.

In a further preferred Example of a titanium polymer composite electrode of the present invention, 75-90 wt % wt of titanium metal is used in HDPE. In a yet further preferred Example, 50-75 wt % titanium metal is used in HDPE.

The present invention also provides a battery comprising a titanium-polymer electrode as described above and may advantageously also include a second electrode that comprises a conductive polymer. A suitable conductive polymer comprises carbon. The battery described above may include an acid electrolyte that may comprise methanesulfonic acid. A redox pair may provide current of the battery, and one element of the redox pair may be a lanthanide that may comprise at least one metal selected from lead, manganese, vanadium, cerium, zinc and cobalt. A preferred lanthanide is cerium and this may be coupled with zinc. Redox pairs comprising Pb—Pb or Co—Co are especially preferred.

Various objects, features, aspects and advantages of the present invention will become more apparent from the following detailed description of preferred embodiments of the invention.

### BRIEF DESCRIPTION OF THE DRAWINGS

The invention will now be described in relation to the following Figures in which:

FIG. 1 shows a monopolar electrode according to the present invention.

FIG. 2 illustrates a schematic drawing of a monopolar composite electrode according to the present invention comprising titanium powder, titanium swarf and high density polyethylene.

FIG. 3 shows a schematic drawing of a single cell laboratory battery.

FIG. 4 shows a bipolar composite electrode according to the present invention comprising titanium powder, high density polyethylene and a catalytic layer.

FIG. 5 shows charge-discharge cycle data obtained using a titanium-HDPE anode and a carbon-HDPE cathode in a lab cell of the kind depicted in FIG. 3.

FIG. 6 shows four full charge and discharge cycles for a polymer composite of the present invention.

FIG. 7 demonstrates the thermal stability of titanium polymer composite electrodes according to the present invention cycling between ambient temperature and 60° C.

FIG. 8 shows a cyclic voltammogram to illustrate that a platinized composite electrode according to present invention comprising titanium swarf and a polymer is capable of performing electrochemistry.

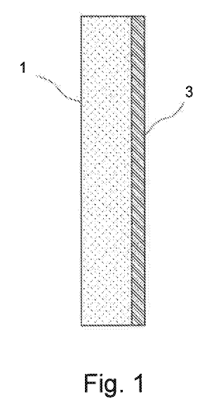

Describing FIGS. 1-4 in more detail:

FIG. 1 depicts a monopolar electrode produced from platinized titanium powder and HDPE polymer 1. The catalytic layer 3 was deposited by vapour deposition, to a thickness of 1-10 microns, or by bonding a layer of platinised (to 1-10 microns) titanium particles, either by heat compaction or diffusion bonding, or any other method of bonding materials. It is also possible for particles of platinised titanium (50 micron) to be spread uniformly across the surface of the moulded electrode and subjected to a compressive load of 2 bar for 50 minutes at 150° C. Loose particles are brushed from the surface of the electrode, leaving a high-surface area of bonded particles.

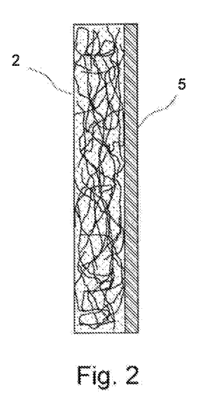

FIG. 2 is depicts another monopolar electrode similar to that of FIG. 1 except it uses a mixture of titanium swarf and titanium power.

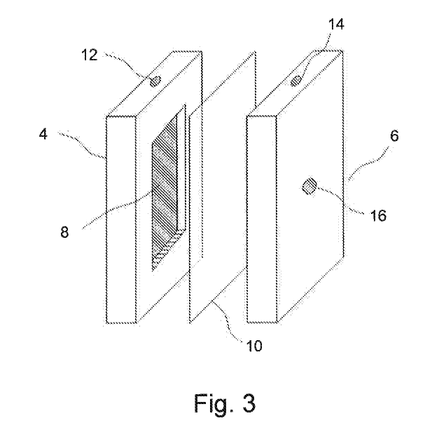

FIG. 3 illustrates a lab single cell battery comprising two generally flat cell bodies 4, 6 for each housing an electrode 8. Sandwiched between the cell bodies 4 and 6 is an ion-exchange membrane 10. Two flow ports 12,14 and an electrical connection 16 are formed in the cell bodies 4 and 6.

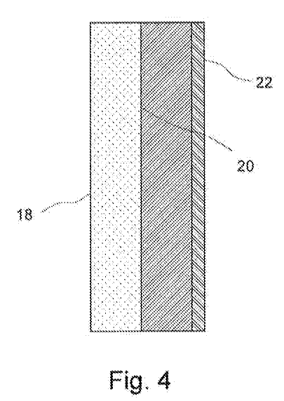

FIG. 4 shows a bipolar electrode with two composite layers: a carbon HDPE layer 18 and a titanium powder/HDPE layer 20. These layers may be produced separately and bonded together by means similar to methods used to bond the catalytic layer 22 or produced in a single process by injection compression or co extrusion.

### DESCRIPTION OF THE EMBODIMENTS

### General Method 1: Preparation of a Polymer Composite Electrodes According to the Present Invention

Polymeric material in pelletised or powdered form is mixed with titanium powder and/or titanium in non-powder form using a 30 mm Buss KoKneader. The mixture is then moulded into a flat or textured electrode using one of a number of techniques, such as compression or injection moulding, or extrusion. The temperature of the process was sufficient for the polymer to flow. The surface of the electrode can be further enhanced by applying fresh titanium powder under compressive load and heat, or a titanium layer by vapour deposition. This coating is then functionalised in a further treatment process; for instance, by applying a thin coating of platinum by vapour deposition or electroplating.

### General Method 2: Preparation of Composite Polymer Electrodes According to the Present Invention

High density polyethylene is melted in a Double Arm Sigma Blade Mixer at 180° C. and to the resulting melt titanium powder and/or titanium in non-powder form is added with the temperature being maintained at 180° C. Batches of the blended mixture were transferred to a furnace to cool to 160° C. before being rolled into sheets of uniform thickness. The edges were trimmed into the required size and shape and finished to remove any burrs.

### General Method 3: Preparation of a Composite Bipolar Electrode

A composite bipolar electrode may be comprised of different filler materials on opposing surfaces. One side may consist of the titanium-based polymer of the kind described above in General Method 1; the other may be an alternative conductive material, such as carbon-based materials similar to those described elsewhere. In producing the electrode, the dissimilar materials may be joined by compressive load and heat, thereby forming a uniform weld, or by diffusion bonding, or adhesion using a conductive epoxy, or at the moulding stage by moulding or coextruding the two materials together.

### General Method 4: Measuring Resistance of Composite Polymer Electrodes

Several different methods to measure the electrical properties of a material are known, however, often these are described to be performed using conditions that are not pertinent to the operating conditions under which the electrode is applied. Also, the results may not be comparable to other materials, which may behave quite differently to each other when subjected to the particular test conditions. For example, one method of measuring electrical through-resistance employed by a manufacturer of carbon-based bipolar electrode materials is to crush the electrode under 1000 psi (68 bar) whilst measuring its conductance. Such a measurement is not representative of its resistance in use, and cannot be used to model voltage drop across a stack of electrochemical cells. In operation, the electrode comes under no measurable compressive load and so must perform as an electrical conductor at these conditions.

The Applicants have therefore devised their own method of measuring electrical resistance using an electrically and mechanically calibrated test apparatus, which applies a small compressive load merely to ensure good electrical contact between the test sample and the apparatus' two contact electrodes. Rather than measure a definitive value of electrical resistance, the figure obtained is a comparative one at known and repeatable conditions that can be used to determine the performance of materials against one another in conditions similar to those applied in operation; and as a measure of thermal stability, since electrical properties of certain materials can be appreciably altered after the application of heat.

In summary the test involves placing a test sample between two conducting electrodes, each having a predetermined and equal surface area. One electrode is fixed and the other attached to a pivoted lever, which is the source of the compressive load. The electrodes are connected to two electrical circuits, the first of which is used to pass a small current through the sample. The second measures the corresponding voltage, from which the resistance can be calculated. Through resistivity can then be calculated, based on the thickness of the sample and the contact surface area.

### Example 1

### Preparation of a Composite Electrode Using HDPE Polymer

General Method 1 was used to make a composite electrode using HDPE polymer in which titanium powder filler (71 wt %) having a particle size of between 200-400 micron was mixed with Borealis PE MG9601 HDPE polymer. The resultant mixture was compression molded using a five cavity 200 t hydraulic press. The resistance of this initial compressed product was measured to be 0.75 Ohmcm using General Method 3 above. The molding step was held for 1 min 45 sec at 3×10⁷ Pa (4400 psi) and employed a platen temperature of 200° C. The so formed composite material was then left in the cavity without pressure and additional heat for another 40 minutes to a surface temperature of about 150° C. To this surface was added fresh titanium powder and the mold was closed and subjected to a compressive load of 2 bar for 50 minutes. Remaining unbound titanium powder was removed after de-molding, resulting in an electrode with a flat electrode surface with good titanium covering. The resistance of the final composite product was measured to be about 0.1-0.2 Ohmcm, measured using General Method 4 described above. This Example clearly shows an electrode or electrode base structure with appropriate conductivity for many electrochemical applications.

### Example 2

Using the same process described above, one side of the composite electrode was platinized by using one of the processes known in the art, for example as described in relation to FIG. 1 above.

### Example 3

Again using the process described in Example 1 one surface of the electrode was derivatized by bonding Carbon-HDPE thereto using a method for example as described in relation to FIG. 4 above

Using General Method 4 for measuring the resistance of composite polymer electrodes, resistances in the range 0.1-1.0 Ohmcm were achieved. These results demonstrate that the present invention is useful to produce bipolar electrodes with two different functionalities.

### Example 4

This Example used General Method 1 but used titanium swarf instead of titanium powder Resistances in the range 0.1-1.0 OhmCm were achieved.

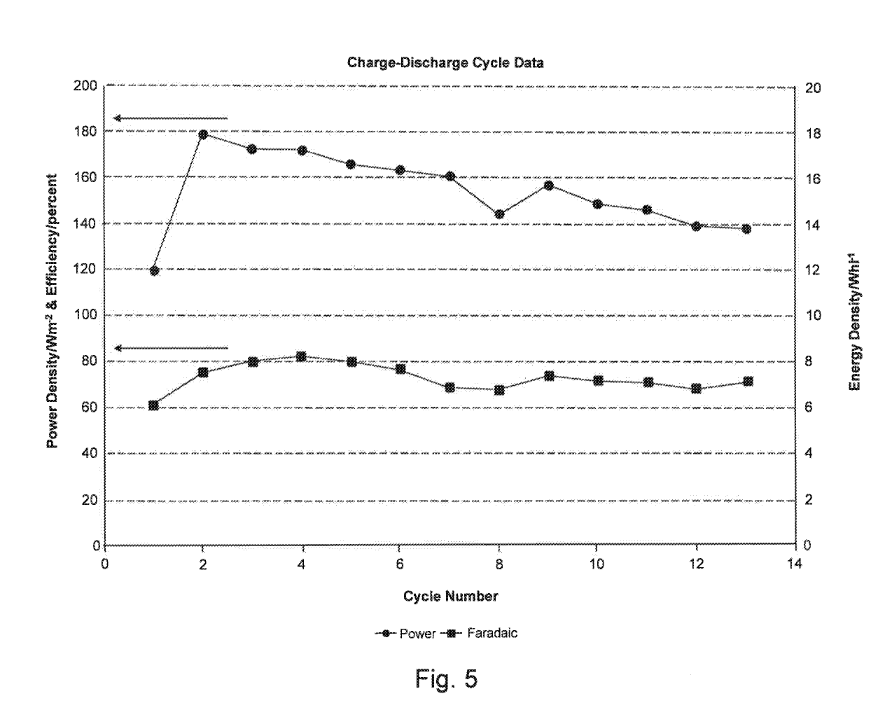

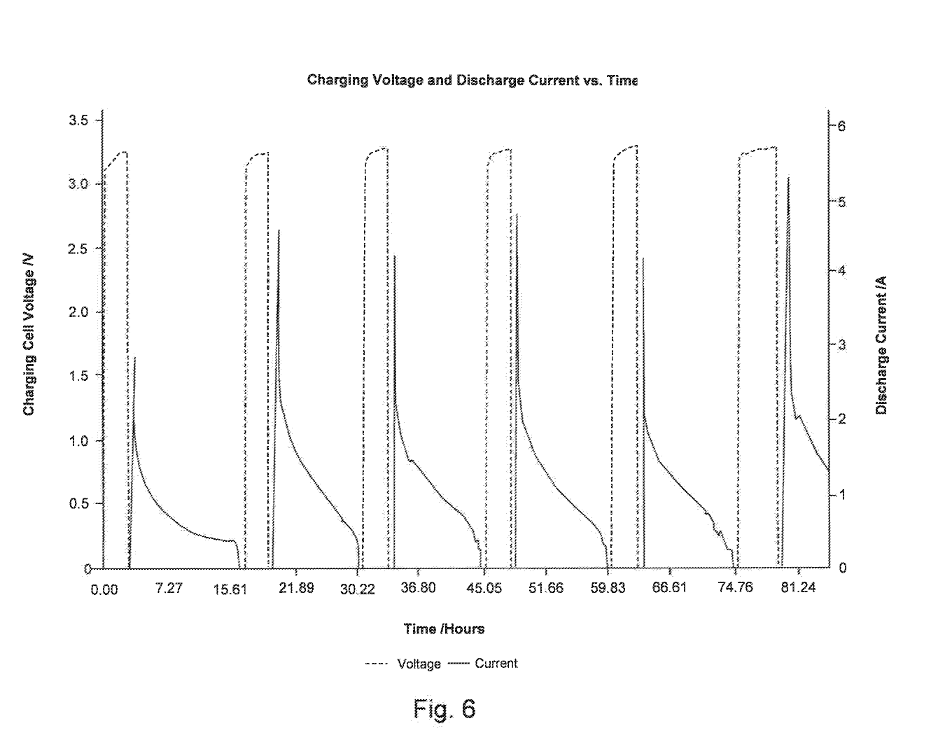

### Discussion of FIGS. 5 and 6

Attached FIGS. 5 and 6 depict exemplary data showing the operation of a lab cell such as that depicted in FIG. 3 with a TiHDPE anode and a CarbonHDPE cathode. Furthermore, various experiments provided the following initial resistivity data of composite electrodes with titanium: 2 mm thick electrode 1.5 Ohmcm; 3 mm thick electrode 1.5 Ohmcm; 1.5 mm thick electrode HDH 1.5 Ohmcm; and 2.0 mm thick electrode HDH 0.5 Ohmcm. Charge-discharge cycles were carried out at 60° C. in a methanesulfonic acid electrolyte and using redox couple with concentrations of 1.0 mol/dm³ Zn²⁺; 2.7 mol/dm³ Ce³⁺. The cell was charged at a constant current of 500 A/m², and discharged at a constant voltage of 1.8V.

FIG. 5 shows the performance over 13 charge-discharge cycles. After the first activation cycle, where an excess of reactants are provided at the top of charge, the battery discharged at a power density between 140 and 180 Wm⁻², and a Faradaic efficiency between 68 and 82%.

FIG. 6 shows four full charge-discharge cycles followed by a fifth, partial cycle for a polymer composite using titanium powder with an average grain size of between about 200-400 micron, present in an amount of at least 60 wt %, with a high-density polyethylene. Charging at constant current, the voltage is shown to increase over time, indicating the state of charge. On discharge at constant voltage, the current discharges initially at a high rate, gradually declining as mass transfer becomes limiting in the reaction. After the initial activating cycle, the area under the discharge curve, which is proportional to the total charge in amp hours, is constant.

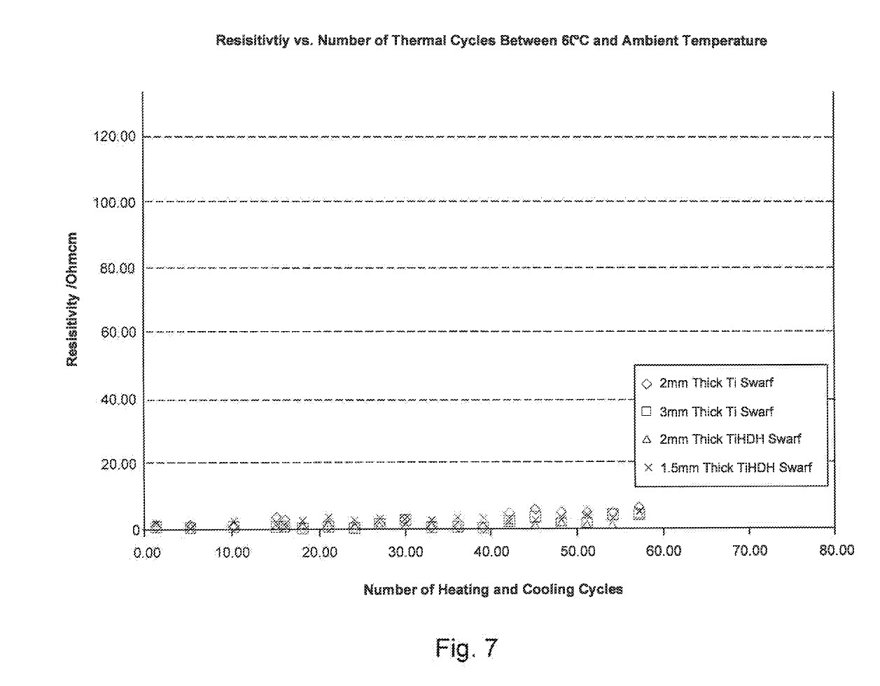

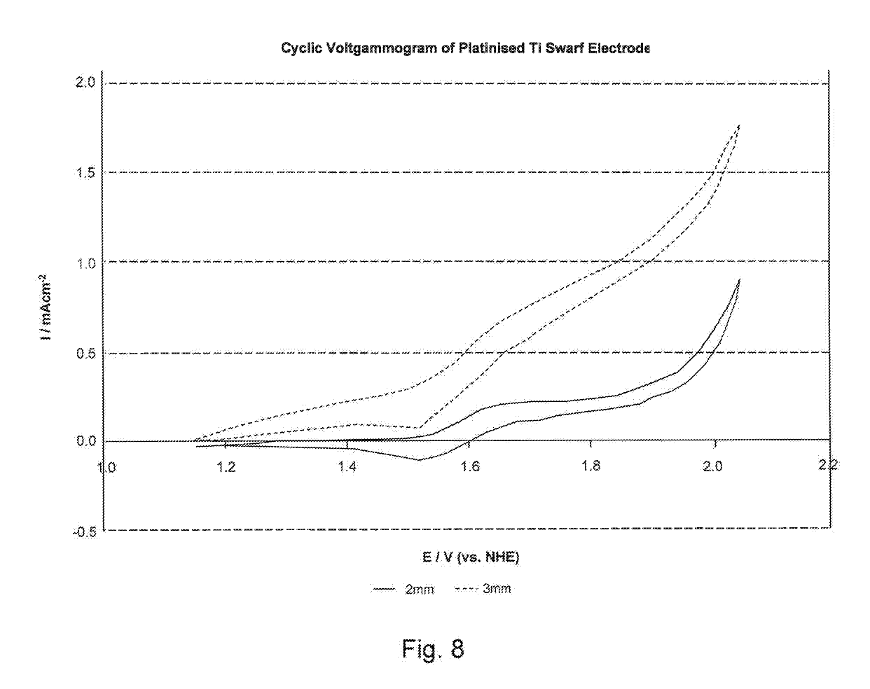

### Discussion of FIGS. 7 and 8

FIG. 7 illustrates the thermal stability of the titanium-polymer composite electrodes of the present invention made using General Method 2 above. Four different samples were used, two containing titanium swarf and two containing titanium powder derived from the hydride dehydride process. In all cases the polymer was HDPE. Resistivity was measured versus the number of thermal cycles between 60° C. (the final operating temperature of a cell) and ambient temperature and as can be observed, the resistivity did not increase even after over 50 cycles, demonstrating that the titanium-polymer composite electrodes of the present invention are highly stable to temperature change.

FIG. 8 shows catalytic activity of platinum-coated Ti-swarf. The higher the current for a given voltage, the better. A full charge-discharge cycle is shown for each electrode. Starting at 0 V (vs NHE) going forward to 2V (top line), the cycle starts with the oxidation (charge) cycle. The higher current of the lab standard shows a higher rate of oxidation from Ce(3+) to Ce(4+). In the reverse cycle (bottom line), the negative hump at 1.4-1.6 V, shows the current on discharge; the rate of reaction reducing Ce(4+) to Ce(3+). Both the 2 and 3 mm electrodes show activity and even better performance will be obtainable upon optimization of the cell—nevertheless these results clearly indicate that platinized titanium composite materials of the present invention are capable for delivering some function as electrodes.

While it should be appreciated that contemplated electrodes may be used in numerous electrochemical processes (e.g., electrochemical conversion of various reagent, plating reactions, etc.), it is especially preferred that contemplated electrodes will be employed in electrical power and energy storage and delivery. Therefore, particularly preferred aspects include use of contemplated electrodes in batteries. In this context, it should be noted that the electrodes may be configured as monopolar electrodes and/or as bipolar electrodes.

Thus, specific embodiments and applications of titanium composite electrodes have been disclosed. It should be apparent, however, to those skilled in the art that many more modifications besides those already described are possible without departing from the inventive concepts herein. The inventive subject matter, therefore, is not to be restricted except in the spirit of the appended claims.

1. A battery comprising a redox pair to provide the current of the battery and a composite electrode comprising a polymeric material and a metallic titanium filler.

2. A battery as claimed in claim 1 wherein the composite electrode comprises a polymer selected from one or more of the group consisting of high-density polyethylene (HDPE), polyethylene (PE), ultra-high molecular weight polyethylene (UHMPE) and any other grades of PE, high-density polypropylene (HDPP), polypropylene (PP), polytetrafluoroethylene (PTFE), polyvinylidene difluoride (PVDF), phenolic resins and vinyl esters, and all polymeric mixtures thereof.

3. A battery as claimed in claim 1 wherein a particulate form of the metallic titanium filler used in the composite electrode is in comprises one or more of powder, swarf, shavings, filings, chips, fibres, mesh, non-woven web, sheet, sponge or foam.

4. A battery as claimed in claim 1 wherein the metallic titanium filler used in the composite electrode comprises powdered titanium metal.

5. A composite electrode as claimed in claim 1 wherein the metallic titanium filler comprises strands of titanium metal swarf.

6. A battery as claimed in claim 1 wherein the composite electrode comprises 75-90 wt % wt of titanium metal in HDPE.

7. A battery as claimed in claim 1 wherein the composite electrode comprises 50-75 wt % of titanium metal in HDPE.

8. A battery as claimed in claim 1 wherein the composite electrode is configured as a bipolar electrode.

9. A battery as claimed in claim 1 wherein the composite electrode further comprises a coating that is deposited in electric contact with the titanium filler onto at least one surface of the electrode.

10. A battery as claimed in claim 9 wherein the coating on the composite electrode is platinum.

11. A battery as claimed in claim 9 wherein the coating on the composite electrode is a mixture of platinum and iridium oxide.

12. A battery of claim 9 wherein the coating on the composite electrode is iridium oxide.

13. (canceled)

14. (canceled)

15. (canceled)

16. A battery as claimed in claim 1 further including a second electrode that comprises a conductive polymer.

17. A battery as claimed in claim 16 wherein the conductive polymer comprises carbon.

18. A battery as claimed in claim 1 wherein the battery comprises an acid electrolyte.

19. A battery as claimed in claim 18 wherein the acid electrolyte comprises methanesulfonic acid.

20. A battery as claimed in claim 1 wherein one element of the redox pair is a lanthanide.

21. A battery as claimed in claim 20 wherein the lanthanide is cerium, and wherein the other element of the redox pair is zinc.

22. A battery as claimed in claim 1 wherein the redox couple comprises at least one metal selected from lead, manganese, vanadium, cerium, zinc and cobalt.

23. A battery as claimed in claim 22 comprising a Pb—Pb or Co—Co redox pair.

24. A method of making a polymer composite electrode comprising the steps:
a) blending metallic titanium with polymer selected from one or more of the group consisting of high-density polyethylene (HDPE), polyethylene (PE), ultra-high molecular weight polyethylene (UHMPE) and any other grades of PE, high-density polypropylene (HDPP), polypropylene (PP), polytetrafluoroethylene (PTFE), polyvinylidene difluoride (PVDF), phenolic resins and vinyl esters, and all polymeric mixtures thereof;
b) moulding the resultant material into an electrode; optionally
c) adding fresh titanium to the surface of the electrode; and further optionally
d) functionalizing the surface of the electrode.

25. A method of making an electrode according to claim 24 wherein step d) involves coating the surface of the electrode with a catalyst material.
